(19) United States
(12) Patent Application Publication
(10) Pub. No.: US 2005/0085374 A1
(43) Pub. Date: Apr. 21, 2005

(54) Heterogenisation of catalytic components

(76) Inventors: Katrin Koehler, Dossenheim (DE); Eike Poetsch, Muehltal (DE); Herbert Schumann, Berlin (DE); Birgit Corinna Wassermann, Berlin (DE); Katharina Lange, Berlin (DE); Ralf Widmaier, Ludwigshafen (DE)

Correspondence Address: MILLEN, WHITE, ZELANO & BRANIGAN, P.C., 2200 CLARENDON BLVD., SUITE 1400, ARLINGTON, VA, 22201, US

(21) Appl. No.: 10/499,705

(22) PCT Filed: Dec. 4, 2002
(86) PCT No.: PCT/EP02/13711

(30) Foreign Application Priority Data
Dec. 21, 2001 (DE) 101 63 457.9

(51) Int. Cl. B01J 23/90

(52) U.S. Cl. 502/22; 423/335

(57) ABSTRACT

The present invention relates to a process for the refunctionalisation of chemically inert, thermally pre-treated metal oxides having an increased number of co-reactive groups on the oxide surface, without producing by-products which have a deactivating effect on catalytic components. The invention furthermore relates to the use of the refunctionalised metal oxides as catalyst supports for the polymerisation of olefins.

The present invention relates to a process for the refunctionalisation of chemically inert, thermally pre-treated metal oxides having an increased number of co-reactive groups on the oxide surface, without producing by-products which have a deactivating effect on catalytic components. The invention furthermore relates to the use of the refunctionalised metal oxides as catalyst supports for the polymerisation of olefins.

Catalytically accelerated reactions can become a problem for the chemist if the catalysts cannot be separated off from the resultant products in a simple manner after completion of the reaction. This is frequently the case in homogeneous catalysis. Although homogeneous catalysis has many advantages, such as higher activities and selectivities, compared with heterogeneous catalysis, its proportion in industrial processes is hitherto low. This is due firstly to the high costs of homogeneous catalysts, which unfortunately cannot yet be reduced by simple recycling of the catalyst. Secondly, no traces of toxicologically and ecologically dubious transition-metal compounds may be present in a multiplicity of chemical products. Catalyst separation after the chemical reaction thus has considerable importance. Heterogeneous catalysts have the major practical advantage that the catalyst immobilised on a surface is very easy to separate off from the product after the reaction. In order to facilitate less expensive and more efficient separation or recycling of homogeneous catalysts, intensive efforts have been made in recent years. Inter alia, the principles of two-phase catalysis and covalent immobilisation of homogeneous catalysts on solid phases have been developed [W. A. Herrmann, B. Cornils, Angew. Chem. 1997, 109, 1074-1095; M. E. Davis, Chemtech 1992, 22, (8), 498]

In covalent immobilisation, chemisorption of the catalyst on a support material takes place through covalent, ionic or coordinative bonding. The catalyst can also be bonded to the support surface via a linker. The support material can be of either an organic or inorganic nature, depending on the application [J. M. J. Frechet et al., Science 1998, 280, 270-273; A. G. M. Barrett et al., Chem. Commun. 1998, 2079-2080]. The most important principle in the preparation of chemisorptively bonded catalysts on inorganic supports, such as, for example, SiO₂, Al₂O₃ or MgO, is the bonding of the catalyst to the hydroxyl groups of the support surface. The surface hydroxyl groups are reacted, for example, with alkyl metal compounds, metal halides or metal alkoxides or functionalised alkoxysilanes with formation of organo-functionalised surfaces [J. Hagen, in “Technische Katalyse” [Industrial Catalysis], VCH Weinheim, 1996, 225-240; M. Z. Cai et al., Synthetic Comm. 1997, 27, 361; D. J. Thompson et al., J. Organomet Chem. 1977, 125, 57-62]. However, the chemisorption of homogeneous catalysts on a support, which is accompanied by the formation of a new bond, in many cases causes the originally advantageous properties of the homogeneous catalysts to be modified in a disadvantageous manner owing to the change in the electronic and steric situation associated with the bond formation. In addition, the chemically bonded catalytic components in the clefts and pores of the support particle may have a different steric environment to those on the surface, which can result in centres with different catalytic activities and in losses of selectivity.

Inorganic support materials have, depending on the chemical structure, a varying number of reactive OH groups on the surface which are able to form a bond to catalytically active organic or organometallic components. This number is about 4.4-8.5 per nm² for a fully hydroxylated silica gel [H. P. Boehm, Angew. Chem. 1966, 78, 617]. These values have been confirmed by J. Kratochvila et al., Journal of Non Crystalline Solids 1992, 143, 14-20. For a bond length of about 1.60 Å for the Si—O bond and a bond angle of 150° for the Si—O—Si bond, about 13 Si atoms per nm² are present on the silica gel surface. This means that a maximum of 13 Si—OH groups occur in the superficial monolayer for an additional triple valence bonding of the silicon via the oxidic oxygen bridges. In general, however, only 4 Si—OH groups can be expected in silica gel dried at room temperature (cf. Boehm and Kratochvila). Drying of these materials at temperatures of up to 175° C. results in partial removal of physisorbed water, but at higher temperatures, adjacent silanol groups, which are absolutely necessary for the immobilisation of catalysts, react with one another with elimination of water. After drying of silica gel materials at temperatures above 700° C., virtually exclusively only siloxane bridges, Si—O—Si, still exist on the surface, meaning that the SiO₂ surfaces have virtually no active SiOH groups any longer and are thus inert for the covalent bonding of chemical units in subsequent reactions [R. K. Ihler, The Chemistry of Silica, Wiley, 1979].

An increase in the number of Si—OH groups on the surface by saturation with water or steam does not result in a satisfactory solution since the catalysts or ligands subsequently to be bonded are hydrolysed by the water additionally adsorbed on the surface and are thus poisoned or catalytically deactivated. Siloxane bridges, Si—O—Si, on the surface of SiO₂ networks can be broken by organoalkali metal compounds, such as phenyllithium or butyllithium. However, this reaction results in partial removal of SiR₄ from the surface leaving ≡Si—OLi units on the surface [H. Boehm, M. Schneider, H. Wistuba Angew. Chem. 1965,14]. No reaction takes place between organoalkaline earth metal compounds and siloxane bridges. It is likewise not possible to use triisobutyl-aluminium to break siloxane bridges, Si—O—Si, on the surface of SiO₂ or TiO₂ networks [M. Liefländer, W. Stöber Z. Naturforschg. 1960, 15b, 411-413].

P19802753 describes a method for increasing and adjusting the number of active OH groups on the oxide surface by reaction of the oxide material with a strongly basic reagent MR, such as alkali or alkaline earth metal hydrides or oxides or organoalkali or -alkaline earth metal compounds followed by protonation using HX. Although a large number of active OH groups can be achieved on the oxide surface in this method, in all cases a salt MX is formed as by-product and in many cases during subsequent catalyst bonding, in particular in the case of extremely reactive, Lewis-acidic catalysts, results in partial or complete poisoning of the catalyst. This is the case, for example, in coordinative polymerisation of olefins using Lewis-acidic metal-containing catalysts from group IVb of the Periodic Table of the Elements. These catalysts can only be employed using a support, since the catalyst support suppresses reactor fouling and prevents agglomeration of the catalytically active centres. Consequently, there is a need for catalyst supports which do not contain deactivating components, but at the same time have a sufficiently large number of co-reactive groups on the support surface for subsequent covalent bonding of the catalytic components. In addition, the support should break up during the polymerisation to form small particles which are uniformly distributed in the resultant polymer, which requires that the catalytic components are also bonded in the pores and clefts of the support. This is very important for further processing of the polymer, since relatively large support particles impair, inter alia, optical properties, such as, for example, the transparency, on use of polyolefins as films, while an excessively small particle size of the support causes unpleasant dusts even during transport and handling, as described, for example, by M. O. Kristen (Topics in Catalysis 1999, 7, 89) and M. R. Ribeiro et al. (Ind. Eng. Chem. Res. 1997, 36, 1224). Consequently, it is also necessary that deactivating components are not present in the interior of the support, such as in the pores and clefts, and that at the same time a sufficiently large number of co-reactive groups for subsequent covalent bonding of the catalytic components is also ensured in the pores and clefts.

The object of the present invention was therefore to develop a process which increases the number of co-reactive groups on the surface of support materials, without at the same time introducing deactivating by-products. The process should also specifically supply those support materials having a sufficiently large number of co-reactive groups on the surface which have obtained a chemically inert surface by thermal pre-treatment for removal of the by-products resulting from the support preparation processes. These co-reactive groups on the support surface should be capable of further covalent bonding of catalytic components, in particular for coordinative polymerisation of olefins. Further aims here were to use support materials having good thermal conductivity and low swellability, to develop an inexpensive and simple method, and to ensure a large number of co-reactive groups also in the pores and clefts of the support material, without at the same time causing occupancy by water molecules or other catalyst poisons. The supported catalysts prepared should advantageously be usable in the polymerisation of olefins.

The present object is achieved by a simple process which refunctionalises chemically inert, thermally pre-treated metal oxides having an increased number of co-reactive groups on the oxide surface, without producing deactivating by-products.

The present application thus relates to a process for the refunctionalisation of co-reactive groups on the surface of thermally pre-treated metal oxides by reaction of thermally pre-treated or chemically inert oxidic materials with aluminium hydrides of the general formula
R R′AlH, (1 )
in a suitable solvent and by subsequent reaction with an alkoxyaluminium compound of the general formula
R R′Al OR″ (2)
with elimination of R″H, (3)
where, in the formulae (1), (2) and (3)
R, R′ and R″, independently of one another, are A, OA, OAlA₂, NA₂ or PA₂,
   and
A is branched or unbranched C₁-C₁₂-alkyl, -cycloalkyl, -alkenyl, -cycloalkenyl, -aryl or -alkynyl.

The invention of this application likewise covers the particular embodiments of this process as claimed in claims 2 to 14 and reproduced in the following description. The present invention furthermore covers the catalyst supports prepared or refunctionalised by the process according to the invention, but also the use thereof in polymerisation, metathesis, hydrogenation, coupling, oxidation and hydroformylation reactions or in the metallocene-promoted polymerisation of olefins or as support materials for single-site catalysts.

Surprisingly, it has been found that aluminium hydrides of the general formula (1) RR′AlH react with optionally thermally pre-treated and also chemically inert oxidic materials in aprotic nonpolar solvents or mixtures thereof with breaking of the oxygen bridges formed during dehydration to give an RR′Al— and hydride-functionalised oxide surface. In a next reaction step, the resultant hydride functions can be converted into a further RR′Al unit on the surface by reaction with an alkoxyaluminium compound, RR′AlOR″, with elimination of R″H: 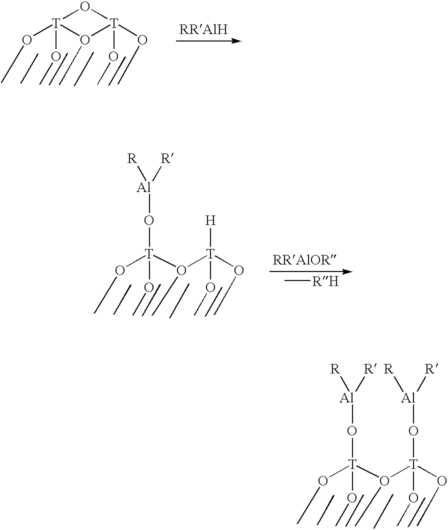
T is a metal atom of the oxide from groups IIa-IVa and IVb of the Periodic Table of the Elements;
R, R′ and R″, independently of one another, are A, OA, OAlA₂, NA₂ or PA₂;
A is branched or unbranched C₁-C₁₂-alkyl, -cycloalkyl, -alkenyl, -cycloalkenyl, -aryl or -alkynyl.

In particular, A

as aliphatic radicals is taken to mean alkyl, the radicals methyl, ethyl, i- and n-propyl, n-, i- and tert-butyl, pentyl, hexyl, heptyl and octyl, as cycloalkyl radicals is taken to mean the radicals cyclopropyl, cyclobutyl, cyclopentyl, cyclohexyl and cycloheptyl,as alkenyl radicals is taken to mean the radicals ethenyl, propenyl, butenyl, butadienyl, pentenyl, pentadienyl, hexenyl, hexadienyl, heptenyl and heptadienyl,as cycloalkenyl radicals is taken to mean the radicals cyclopentenyl, cyclohexenyl and cycloheptenyl,-as aryl radicals is taken to mean phenyl, naphthyl or mono- or poly-alkyl-substituted naphthyl, or alkynyl radicals.

A is particularly preferably taken to mean the radicals methyl, ethyl and i-propyl.

This reaction enables inert oxide surfaces to be provided with an adequately large number of co-reactive groups without the formation of deactivating by-products.

The reaction according to the invention can be used in a simple process in which a metal-oxide from one of groups IIa-IVa and IVb of the Periodic Table of the Elements, optionally after prior thermal pre-treatment in a high vacuum at temperatures in the range from 20 to 1000° C. in an aprotic solvent, is reacted with a compound of the general formula (1) RR′AlH, in which R and R′ are as defined above, and is stirred at a temperature in the range from 0 to 150° C. for from 5 minutes to 2 days. The stirring is preferably carried out at a temperature in the range from 50 to 120° C. for from 1 to 8 hours. The resultant reaction product can be separated off, washed with the same solvent and dried in an oil-pump vacuum and reacted subsequently or directly in situ with a compound of the general formula (2) RR′AlOR″, in which R, R′ and R″ are as defined above. To this end, a suspension of the reaction product obtained by reaction with the compound of the general formula (1) is prepared and stirred at a temperature in the range from 0 to 150° C. for from 5 minutes to 3 days, preferably in the range from 30 to 80° C. for from 5 to 30 hours. The resultant product is separated off. Preferably, both the reaction of a metal oxide with a compound of the general formula (1) and the reaction with compounds of the general formula (2) are carried out under a protective-gas atmosphere. Protective gases which can be used here are nitrogen and argon.

Solvents which are suitable for carrying out the process can be hydrocarbons or aprotic nonpolar solvents, such as, for example, diethyl ether, dioxane, tetrahydrofuran or tetrachloromethane, or mixtures of these solvents. The hydrocarbons can be either aliphatic or aromatic hydrocarbons. Suitable hydrocarbons include, inter alia, pentane, hexane, heptane, benzene, toluene and xylene. Further suitable hydrocarbons are known to the person skilled in the art and can be selected depending on the starting compounds.

The catalyst supports used can be metal oxides from one of groups IIa-IVa and IVb of the Periodic Table of the Elements, such as oxides of silicon, aluminium, magnesium, titanium and zirconium, and mixed oxides of silicon/aluminium, silicon/titanium and silicon/zirconium. Preference is given to oxides of silicon, such as, for example, silica gels, broken SiO₂, spherical SiO₂, monolithic SiO₂ and spherical monodisperse SiO₂, and of aluminium. Particular preference is given to oxides, in particular that of silicon having a particle size of from 10 nm to 250 μm, a particle surface area of from 10 to 1000 m²/g and a pore volume of 0-15 ml/g, preferably having a pore volume of 0-5 ml/g. Further suitable metal oxides are known to the person skilled in the art and can be selected depending on the subsequent application of the refunctionalised supports.

The oxide surfaces refunctionalised with RR′Al units can be converted, by reaction with compounds containing acidic hydrogen atoms, into a multiplicity of co-reactive groups on the oxide surface, which can be used for linking ligands and/or catalytic components. Preference is given for this purpose to the use of compounds containing acidic hydrogen atoms from the group consisting of water, alcohols, amines, carboxylic acids and acetylenes. Particular preference is given to the use of alcohols and water. Further suitable compounds are known to the person skilled in the art and can be selected depending on the subsequent application of the refunctionalised supports.

The refunctionalised supports obtained by the process according to the invention can be employed as catalyst supports, in particular for polymerisation, metathesis, hydrogenation, coupling, oxidation or hydroformylation reactions. It has been found that the refunctionalised oxide materials serve as support materials for single-site catalysts. The method according to the invention is particularly suitable for the preparation of supports for the catalytic polymerisation of olefins. Particularly good results are achieved on use of the refunctionalised supports in metallocene-promoted polymerisation of olefins. The catalytic components consisting of a cocatalyst, such as, for example, methylaluminoxane, and a catalyst, such as, for example, a metallocene compound, are immobilised on the refunctionalised support materials. Further suitable cocatalysts and catalysts for the polymerisation of olefins are known to the person skilled in the art and can be selected depending on the polymerisation process. Corresponding supported catalysts can be employed in olefin polymerisation reactions.

The object on which the invention is based is achieved, in particular, by a process in which compounds of the general formula (1)
RR′AlH,
in which
R and R′ independently of one another, are A or OAlA₂;
A is branched or unbranched C₁-C₁₂-alkyl or -aryl
   and compounds of the general formula (2)
   RR′AlOR″,
   in which
R, R′ and R″, independently of one another, are A or OA;
A is branched or unbranched C₁-C₁₂-alkyl or -aryl, are employed.

From this group of compounds, particularly good results are achieved by those in which
A is branched or unbranched C₁-C₄-alkyl.

It has been found that, in particular, the compounds selected from the group consisting of the general formula (1) RR′AlH,
dimethylaluminium hydride
diethylaluminium hydride
diisopropylaluminium hydride
diisobutylaluminium hydride
   and the compounds selected from the group consisting of the general formula (2) RR′AlOR″,
dimethylaluminium methoxide
diethylaluminium ethoxide
diisopropylaluminium propoxide
diisobutylaluminium butoxide
aluminium triethoxide
aluminium triisopropoxide
aluminium tributoxide
   can be employed particularly well for the refunctionalisation of metal oxides.

Experiments have shown that the compounds
diethylaluminium hydride
diisobutylaluminium hydride
   and
diethylaluminium ethoxide
   are preferably suitable for this purpose and result in a large number of co-reactive dialkylaluminium units on the metal-oxide surface.

Particularly high activities are obtained in the polymerisation of olefins if catalyst supports are employed which have previously been refunctionalised with the compounds
diethylaluminium hydride
   and
diethylaluminium ethoxide.

The stepwise thermal pre-treatment of the SiO₂ supports in a high vacuum at temperatures in the range from 20° C. to 1000° C. with subsequent cooling in a protective-gas atmosphere results, with loss of the surface bonded reactive silanol groups, in the removal of the physisorbed, volatile components, such as, for example, water, alcohols, ammonia and polar solvents resulting from the support preparation process. The thermal pre-treatment has an extremely advantageous effect on the subsequent heterogenisation of catalytic and cocatalytic components, since the proportion of potential catalyst poisons in the support material is greatly reduced.

The process described here for the refunctionalisation of the chemically inactive metal-oxide surface present after drying produces a co-reactive functionalised SiO₂ surface which has a larger number of co-reactive groups on the surface (6-8 per nm² based on aluminium, 12-16 per nm² based on hydroxyl groups) compared with SiO₂ materials at room temperature containing only 4 hydroxyl groups per nm² of surface or compared with SiO₂ materials pre-treated at 1000° C. no longer containing any hydroxyl groups on the surface. This process also enables chemical refunctionalisation of the metal-oxide surfaces without the production of deactivating by-products which act as potential catalyst poisons.

In addition, it has been found that the refunctionalised oxide materials serve as support materials for, for example, single-site catalysts. As an example, the diorganylaluminium-charged refunctionalised supports were partially hydrolysed and reacted with the cocatalytic component methylaluminoxane (MAO) and the precatalytic component zirconocene dichloride [(η⁵—C₅H₅)₂ZrCl₂] and used for the catalytic polymerisation of olefins for the preparation of polyethylene.

In the polymerisation of ethylene in combination with aluminium-containing cocatalysts and metallocene catalysts, the refunctionalised metal-oxide supports result in an increase in activity by 25% compared with the support-free homogeneous system (η⁵—C₅H₅)₂ZrCl₂/MAO. The loss in activity described in the literature on changing from homogeneous catalyst systems to oxide-supported catalyst systems in the metal-locene-promoted polymerisation of olefins can be eliminated with the above-mentioned refunctionalised oxide materials and the activities even increased [M. O. Kristen, Topics in Catalysis 1999, 7, 89].

It has furthermore been found that the R₂Al functions on the refunctionalised oxide surfaces already have cocatalytic properties in the Ziegler-Natta polymerisation of ethylene in combination with titanium halides or vanadium halides.

The process according to the invention is thus particularly suitable for the reactivation and chemical functionalisation of oxidic catalyst support materials which have lost their active surface functions, for example due to a drying process, but which are necessary for the physisorption or chemisorption of homogeneous or even heterogeneous catalyst systems or components.

For better understanding and in order to illustrate the invention, examples are given below which fall within the scope of protection of the present invention. However, owing to the general validity of the inventive principle described, these are not suitable for reducing the scope of protection of the present application to just these examples.

### EXAMPLES

Thermal Pre-Treatment of the SiO₂ (for Example Monospher 250)

For pre-drying, the SiO₂ (Monospher 250) is dried in a Schlenk flask at 150° C. for 6 hours in a vacuum of 10⁻²-10⁻³ mbar (weight loss 3-4%). The pre-dried SiO₂ is then transferred into a porcelain boat located in a quartz tube provided with ground-glass caps and taps. The quartz tube containing the SiO₂ is heated at 1000° C. for 24 hours in a vacuum of 10⁻²-10⁻³ mbar in a tubular furnace. The heating phase is controlled via a temperature ramp of 1° C./min. After completion of the heating phase at 1000° C., the cooling phase takes place under an inert-gas atmosphere (N₂). A weight loss of 8% is obtained, based on the SiO₂ pre-treated at 150° C.

Chemical Refunctionalisation of the Oxide Surface of SiO₂ (for Example Monospher 250) with RR′AlH and R″AlOR″

### Example 1

R=R′=R″=ethyl

12 g of the SiO₂ pre-treated at 1000° C. (Monospher 250) are suspended in 40 ml of toluene in a 100 ml Schlenk flask. 5 ml of Et₂AlH are added dropwise by means of a syringe through a septum. The concentration of Et₂AlH in the reaction solution is 1.1 mol/l. The suspension is subsequently refluxed for 4 hours. The support freed from solvent by filtration or centrifugation is washed three times with 20 ml of hexane each time. The support dried in an oil-pump vacuum is then suspended in 20 ml of toluene in a 100 ml Schlenk flask. 11 ml of Et₂AlOEt (1.6 mol/l in toluene) are added dropwise by means of a syringe through a septum. After refluxing for 20 hours, the support is worked up analogously to the first reaction step.

Aluminium AAS: 3.2 mg of Al/g (0.12 mmol of Al/g) or 6.0 Al groups/nm² (surface_{Monospher 250}=12 m²/g)

### Example 2

R=R′=isobutyl, R″=ethyl

9.1 g of the SiO₂ pre-treated at 1000° C. (Monospher 250) are suspended in 20 ml of toluene in a 100 ml 2-necked Schlenk flask. 46 ml of a 1M hexane solution of ⁱBu₂AlH are added dropwise by means of a syringe-through a septum. The concentration of ⁱBu₂AlH in the reaction solution is 0.7 mol/l. The suspension is subsequently refluxed for 4 hours. The support freed from solvent by filtration or centrifugation is washed five times with 20 ml of hexane each time. The support dried in an oil-pump vacuum is then suspended in 50 ml of toluene in a 100 ml Schlenk flask. 10 ml of a 1.6M toluene solution of Et₂AlOEt are added dropwise by means of a syringe through a septum. After refluxing for 19 hours, the support is separated off by filtration or centrifugation and washed four times with 20 ml of toluene each time and twice with 20 ml of hexane each time and subsequently dried in an oil-pump vacuum.

Aluminium AAS: 3.9 mg of Al/g (0.14 mmol of Al/g) or 7.3 Al groups/nm² (surface_{Monospher 250}=12 m²/g)

### Example 3

R=isobutyl, R′=OAlⁱBu₂, R″=ethyl

10.22 g of SiO₂ (Monospher 250) are suspended in toluene in a 100 ml 2-necked Schlenk flask. 50 ml of a 10% toluene solution of ⁱBu₂AlOAl(H)ⁱBu are added dropwise by means of a syringe through a septum. The concentration of ⁱBu₂AlOAl(H)ⁱBu in the reaction solution is 0.26 mol/l. The suspension is subsequently stirred at an oil-bath temperature of 90° C. for 4 hours. The cooled suspension is worked up by filtration or centrifugation. The support freed from solvent is washed six times with 10 ml of toluene each time and once with 20 ml of pentane. The support dried in an oil-pump vacuum is then suspended in 20 ml of toluene in a 100 ml Schlenk flask. 20 ml of a 1.6M toluene solution of Et₂AlOEt are added dropwise by means of a syringe through a septum. After refluxing for 19 hours, the cooled suspension is worked up by filtration or centrifugation. The SiO₂ freed from solvent is washed three times with 20 ml of toluene each time and three times with 10 ml of hexane each time and subsequently dried in an oil-pump vacuum.

Aluminium AAS: 2.2 mg of Al/g ((0.08 mmol of Al/g) or 4.1 Al groups/nm² (surface_{Monospher 250}=12 m²/g)

Use of the Refunctionalised SiO₂ as Catalyst Support in the Metallocene-Promoted Polymerisation of Ethylene

A toluene solution of methylaluminoxane is introduced into a 1 l Büchi glass autoclave, and the organoaluminium-functionalised support based on SiO₂ (Monospher 250) described under Example 1 is added as a toluene suspension, and the mixture is subsequently stirred at 30° C. for half an hour. A toluene solution of Cp₂ZrCl₂ is then injected, and the mixture is stirred for a further ten minutes. 2 bar of ethylene are injected, and the pressure and temperature are kept constant throughout the polymerisation time. After a reaction time of one hour, the polymerisation is terminated by decompression and addition of ethanol. For work-up, the toluene suspension of polymer is stirred with dilute hydrochloric acid for several hours and subsequently filtered, washed until neutral and dried to constant weight.

Czr=110⁻⁵ mol/l, Al:Zr=5000:1, T=30° C., pₑₜₕₑₙₑ=2 bar, t=1 h

| | Activity |
|---|---|
| Support (Ex. 1) | [kg of PE/mol_{Zr} cₑₜₕₑₙₑ h] |
| None | 28,700 |
| 0.55 g | 27,200 |
| 0.72 g | 35,800 |

1. Process for the refunctionalisation of co-reactive groups on the surface of thermally pre-treated metal oxides by reaction of thermally pre-treated or chemically inert oxidic materials with aluminium hydrides of the general formula
R R′AlH, (1)
in a suitable solvent and by subsequent reaction with an alkoxyaluminium compound of the general formula
R R′Al OR″ (2)
with elimination of R″H, (3)
where, in the formulae (1), (2) and (3)
R, R′ and R″, independently of one another, are A, OA, OAlA₂, NA₂ or PA₂,
and
A is branched or unbranched C₁-C₁₂-alkyl, -cycloalkyl, -alkenyl, -cycloalkenyl, -aryl or -alkynyl.

2. Process according to claim 1, characterised in that the solvents used are hydrocarbons or aprotic nonpolar solvents, or mixtures thereof.

3. Process according to claim 1 , characterised in that hydrocarbons selected from the group consisting of pentane, hexane, heptane, benzene, toluene and xylene, or mixtures thereof, are used as solvent.

4. Process according to claim 1 , characterised in that aprotic nonpolar solvents selected from the group consisting of dioxane, diethyl ether, tetrahydrofuran and tetrachloromethane, or mixtures thereof, are used.

5. Process according to claim 1, characterised in that a metal oxide from one of groups IIa-IVa and IVb of the Periodic Table of the Elements is refunctionalised.

6. Process according to claim 1, characterised in that the reaction of a metal oxide, optionally after prior thermal pre-treatment in a high vacuum at temperatures in the range from 20 to 1000° C., with a compound of the general formula (1) is carried out at a temperature in the range from 0 to 1 50° C. with stirring over the course of from 5 minutes to 2 days.

7. Process according to claim 6, characterised in that the reaction is carried out at a temperature in the range from 50 to 120° C. with stirring over the course of from 1 to 8 hours.

8. Process according to claim 1 , characterised in that the product of the reaction of the metal oxide with a compound of the general formula (1) is reacted directly in situ or, after separation, washing with solvent and drying, in suspension with a compound of the general formula (2) at a temperature in the range from 0 to 150° C. with stirring over the course of from 5 minutes to 3 days.

9. Process according to claim 8, characterised in that the reaction with a compound of the general formula (2) is carried out at a temperature in the range from 30 to 80° C. with stirring over the course of from 5 to 30 hours.

10. Process according to claim 1 , characterised in that both the reaction of a metal oxide with a compound of the general formula (1) and the reaction with compounds of the general formula (2) are carried out under a protective-gas atmosphere.

11. Process according to claim 1, characterised in that the metal oxide used is an oxide selected from the group consisting of silicon oxide, aluminium oxide, magnesium oxide, titanium oxide and zirconium oxide or a mixed oxide selected from the group consisting of silicon/aluminium, silicon/titanium and silicon/zirconium oxide.

12. Process according to claim 1, characterised in that the oxide used is an oxide of silicon from the group consisting of silica gel, broken SiO₂, spherical SiO₂ and monolithic SiO₂, spherical monodisperse SiO₂ or aluminium oxide.

13. Process according to claim 1 , characterised in that oxides having a particle size of from 10 to 250 μm and a particle surface area of from 10 to 1000 m²/g and a pore volume of 0-15 ml/g, preferably 0-5 ml/g, are used.

14. Process according to claim 1, characterised in that the product obtained is reacted with a compound containing acidic hydrogen atoms from the group consisting of water, alcohol, amine, carboxylic acid and acetylene.

15. Refunctionalised catalyst support which can be prepared by a process according to claim 1.

16. Use of the refunctionalised catalyst support prepared by a process according to claim 1 in polymerisation, metathesis, hydrogenation, coupling, oxidation and hydroformylation reactions or as support material for single-site catalysts

17. Use of the refunctionalised catalyst support prepared by a process according to claim 1 in the metallocene-promoted polymerisation of olefins.
